(19) United States
(12) Patent Application Publication
(10) Pub. No.: US 2004/0057533 A1
(43) Pub. Date: Mar. 25, 2004

(54) System and method for performing predistortion at intermediate frequency

(76) Inventor: Munawar Hussein Kermalli, Floral Park, NY (US)

Correspondence Address: Docket Administrator (Room 3J-219), Lucent Technologies Inc., 101 Crawfords Corner Road, Holmdel, NJ, 07733-3030, US

(21) Appl. No.: 10/252,887

(22) Filed: Sep. 23, 2002

(51) Int. Cl. H04K 1/02

(52) U.S. Cl. 375/296

(57) ABSTRACT

A predistortion system predistorts a signal to be amplified at an intermediate frequency (IF). In certain embodiments, the IF predistortion system frequency downconverts the radio frequency (RF) signal to be amplified to an IF frequency. The IF signal is predistorted and frequency upconverted back to RF prior to amplification. For example, the IF signal can be analog to digitally converted, and the digital IF signal is predistorted. The predistorted digital IF signal is converted back to an analog IF signal, and the analog IF signal is then upconverted to RF prior to amplification.

### BACKGROUND OF THE INVENTION

1. Field of the Invention

This invention relates to signal processing and, more particularly, to a system and method for performing intermediate frequency (IF) predistortion.

2. Description of Related Art

An ideal power amplifier amplifies an input signal with no waveshape alteration. The ideal power amplifier is therefore characterized as having a transfer function (input signal vs. output signal) which is linear with no transfer function discontinuities. In practice, however, a power amplifier has a transfer function with nonlinear and “linear” regions. Whether the power amplifier is operating in a linear or nonlinear region depends in part on the amplitude of the input signal. For the power amplifier to achieve as near to linear operation as possible, the power amplifier is designed to operate within its linear region given the range of possible input signal amplitudes. If the input signal has an amplitude which causes the power amplifier to operate outside the linear region, the power amplifier introduces nonlinear components or distortion to the signal. When the input signal possesses amplitudes which cause the amplifier to compress or to saturate (no appreciable increase in output amplitude with an increase in input amplitude), the output signal is clipped or distorted in a nonlinear fashion. Generally, an amplifier is characterized as having a clipping threshold, and input signals having amplitudes beyond the clipping threshold are clipped at the amplifier output. In addition to distorting the signal, the clipping or nonlinear distortion of the input signal, generates spectral regrowth or adjacent channel power (ACP) that can interfere with an adjacent frequency channel.

In wireless communications systems, high power amplification of signals for transmission are commonly encountered with very large peak to average power ratios (PAR). For example, in a time division multiple access (TDMA) system, such as Global System for Mobile Communications (GSM) or North American TDMA, when multiple carrier signals are combined for amplification with a power amplifier, the resulting PAR is about 9-10 dB for a large number of carriers. In a code division multiple access (CDMA) system, a single loaded 1.25 Mhz wide carrier can typically have a PAR of 11.3 dB. For orthogonal frequency division multiplexing (OFDM), multicarrier signals can have a PAR of up to 20 dB. These signals have to be amplified fairly linearly to avoid generating ACP.

Unfortunately, efficiency of the base station amplifier is inversely related to its linearity. To achieve a high degree of linearity, the amplifiers are biased to operate in the class A or “slight” class AB (meaning class AB operation that is closer to class A than to class B). Maximum AC to DC efficiency achievable for class A operation is 50%, whereas that of a class AB amplifier is between 50 and 78.5% (the latter representing the maximum efficiency of a class B amplifier). The closer the particular class AB operation is to class A, the lower the maximum efficiency. For amplifiers employing field effect transistors, the class of operation is set in accordance with the gate voltage applied, which controls the quiescent (idle) drain current. For class A operation, the gate voltage is set so that the idle drain current is approximately in the middle of the range between cutoff and saturation. Class B amplifiers are biased near cutoff, resulting in a rectified drain current waveform. Class AB amplifiers are biased in between the bias points of classes A and B. Furthermore, because of the high PAR, the operating point needs to be backed off significantly from the ideal maximum efficiency points described above.

Typically, strict linearity requirements in modern wireless communication systems dictate the use of the relatively inefficient class A or slight class AB modes. As a result, significant DC power is dissipated by the amplifiers, thereby generating heat which must be controlled to avoid degrading amplifier performance and reliability. Hence, the use of elaborate heat sinks and fans become a necessary by-product of the high linearity system. Naturally, these measures add to the cost, size and weight of the base station equipment. As the number of wireless communications users continues to grow, so do the number of base stations and the need to keep them small, light and inexpensive. Thus, a great deal of research has focused on the quest to improve amplifier efficiency in these and other systems.

Various linearization methods are used to enable the use of more cost-effective and more power efficient amplifiers while maintaining an acceptable level of linearity. Feed-forward correction is routinely deployed in modern amplifiers to improve the linearity of the main amplifier with various input patterns. The essence of the feed-forward correction is to isolate the distortion generated by the main amplifier on a feed forward path. The distortion is provided to a correction amplifier on the feed forward path which amplifies the distortion. The distortion on the feed forward path is combined with the distortion on the main signal path to cancel the distortion on the main signal path. Pre-distortion techniques distort the input signal prior to amplification by taking into account the transfer function characteristics for the amplifier. As such, the desired amplified signal is achieved from the pre-distorted input signal by intentionally distorting the signal before the amplifier, so the non-linearity of the amplifier can be compensated.

FIG. 1a shows a block diagram of an adaptive power amplifier digital predistortion system 10. The baseband digital input signal is provided with in-phase (I) and quadrature (Q) components to a predistortion function 14 (A(.)) to produce a predistorted I and Q signals which are provided to an I/Q modulator 16 to produce a complex signal for transmission. After digital to analog conversion by digital to analog (D/A) converter 18, the resulting analog signal is frequency up-converted in an up-conversion process 19 (which can include filters and upconverters) to radio frequency (RF). In this example, the signal is upconverted to a carrier frequency f_{c}. The analog RF signals are amplified by power amplifier 20 for transmission over the air using antenna 22. A replica of the amplified analog RF signals is coupled off the main signal path onto a predistortion feedback path 24. The analog RF signals on the predistortion feedback path 24 are down-converted by a down-conversion process 26 (which can include filters and downconverters).

The down-converted analog signals on the predistortion feedback path 24 are provided to an analog to digital (A/D) converter 28 for conversion into the digital domain. The resulting digital signal, which represents the output of the amplifier 20, is provided to an I/Q demodulator 29 which provides a baseband digital signal with I and Q components to an amplifier characteristics estimation block 30. Given the digital signals I and Q after the predistortion function 14 and the digital signals from the I/Q demodulator 29 which are based on the output of the amplifier 20, the amplifier characteristics estimation block 30 can determine the characteristics or model function of the amplifier 20. Once the model of the amplifier 20 is estimated, a predistortion calculation process 34 determines the predistortion function as the inverse of the amplifier characteristics function, and the predistortion function 14 (A(.)) applied to the input signal is updated based on the predistortion calculation process 34.

FIG. 1b shows a block diagram of an alternative embodiment of an adaptive power amplifier digital predistortion system 40. The baseband digital input signal is provided with in-phase (I) and quadrature (Q) components input into a predistortion function 44 (A(.)) to produce a predistorted I and Q signals. The predistorted I and Q signals are provided to respective digital to analog converters 46a and 46b to produce analog predistorted I and Q signals. The analog predistorted I and Q signals are provided to an I/Q modulator and upconversion process 48 (which can include an I/Q modulator, filters and upconverters) to produce a complex signal at RF for transmission. In this example, the complex signal is upconverted to a carrier frequency f_{c}. The analog RF signals are amplified by power amplifier 50 for transmission over the air using antenna 52. A replica of the amplified analog RF signals is coupled off the main signal path onto a predistortion feedback path 54. The analog RF signals on the predistortion feedback path 54 are down-converted by a down-conversion process 56 (which can include filters and down-converters).

The down-converted analog signals on the predistortion feedback path 54 are provided to an analog to digital (A/D) converter 58 for conversion into the digital domain. The resulting digital signal is provided to an I/Q demodulator 59 which provides a baseband digital signal with I and Q components to an amplifier characteristics estimation block 60. Given the digital signals I and Q after the predistortion function 44 and the digital signals from the I/Q demodulator 59 which are based on the output of the amplifier 20, the amplifier characteristics estimation block 30 can determine the characteristics or model function of the amplifier 50. Once the model of the amplifier 50 is estimated, a predistortion calculation process 64 determines the predistortion function as the inverse of the amplifier characteristics function, and the predistortion function 44 (A(.)) applied to the input signal is updated based on the predistortion calculation process 64.

In current systems, the output of the amplifier is coupled off to a predistortion feedback path and downconverted to digital baseband to update the predistortion function. Such downconversion requires not only frequency downconversion but also I/Q demodulation. As such, errors introduced as part of the demodulation and downconversion process can effect the performance of the predistortion system. Additionally, since current adaptive predistortion schemes require down-conversion to digital baseband, amplifier manufacturers who desire to provide predistortion schemes with amplifier products must intrude into the digital domain of the radio manufacturers Accordingly, a need exists for a predistortion system that reduces the above-mentioned drawbacks of current schemes.

### SUMMARY OF THE INVENTION

The present invention is a predistortion system which predistorts a signal to be amplified at an intermediate frequency (IF). In certain embodiments, the IF predistortion system frequency downconverts the radio frequency (RF) signal to be amplified to an IF frequency. The IF signal is predistorted and frequency upconverted back to RF prior to amplification. For example, the IF signal can be analog to digitally converted, and the digital IF signal is predistorted. The predistorted digital IF signal is converted back to an analog IF signal, and the analog IF signal is then upconverted to RF prior to amplification.

### BRIEF DESCRIPTION OF THE DRAWINGS

Other aspects and advantages of the present invention may become apparent upon reading the following detailed description and upon reference to the drawings in which:

FIGS. 1A and 1B show general block diagrams for a typical adaptive power amplifier predistortion system;

FIG. 2 shows a general model of an IF predistortion system according to principles of the present invention;

FIG. 3 shows an embodiment of predistortion circuitry using a Hilbert transform according to principles of the present invention;

FIG. 4 shows an embodiment of predistortion circuitry using a Quadrature Hybrid according to principles of the present invention; and

FIGS. 5A and 5B show an analog embodiment of predistortion circuitry according to principles of the present invention.

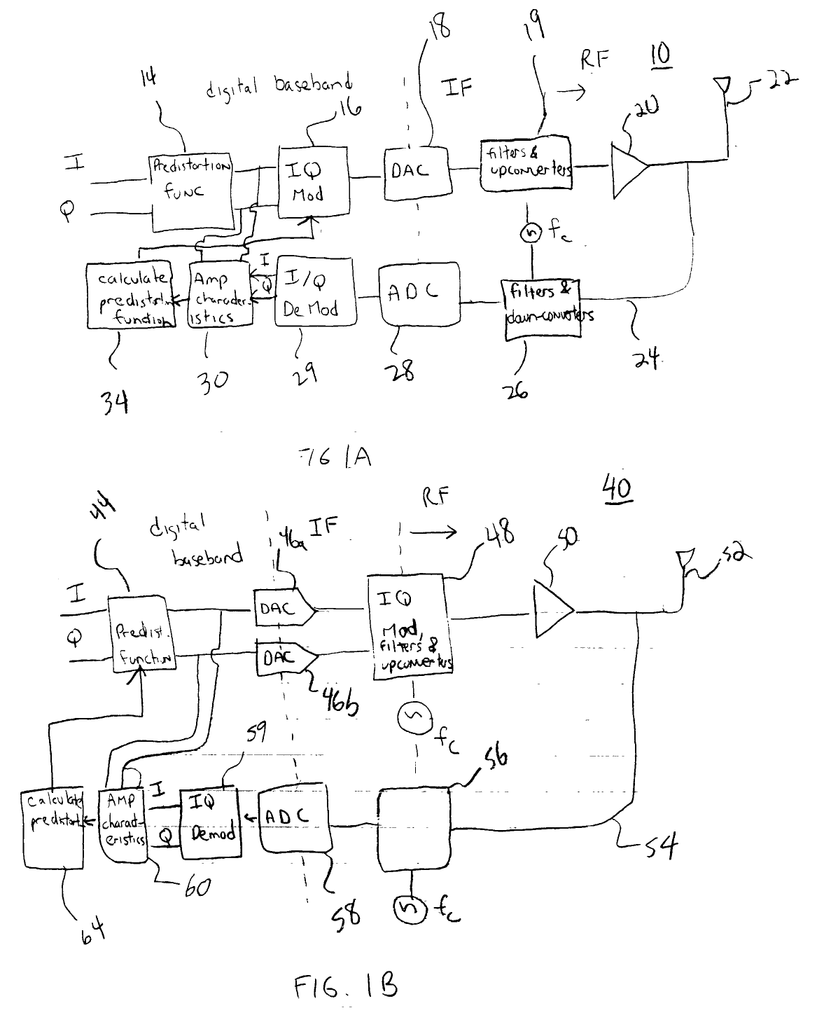

### DETAILED DESCRIPTION

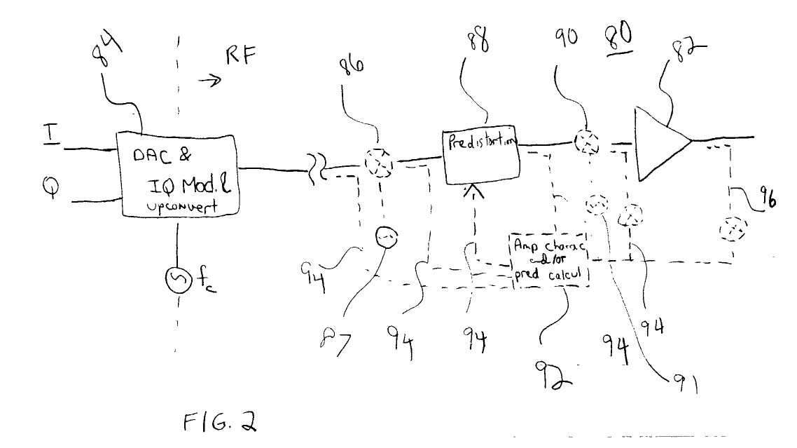

Illustrative embodiments of the IF predistortion circuitry are described according to the principles of the present invention which predistorts a signal to be amplified at an intermediated frequency (IF). FIG. 2 shows a general block diagram of an amplification system 80 using the IF predistortion system. In this example, an amplifier 82 is used to amplify a radio frequency (RF) analog signal having in-phase (I) and quadrature (Q) components produced by digital to analog converter (DAC), I/Q modulator and upconverter circuitry (to the carrier frequency fc) 84. Prior to amplification, the IF predistortion system 80 frequency downconverts the radio frequency (RF) signal using a mixer 86 and an oscillator 87. The downconverted IF signal is predistorted by predistortion circuitry 88. In this example, the predistorted IF signal is frequency upconverted back to RF using a mixer 90 and oscillator 91, and then the amplifier 82 amplifies the predistorted RF signal.

Depending on the embodiment, the predistortion circuitry 88 may analog to digitally convert the IF signal prior to applying predistortion in the digital domain. Alternatively, the predistortion circuitry can predistort the IF analog signal in the analog domain. If analog to digital conversion of the RF signal is performed prior to predistortion, then frequency downconversion using the mixer 86 may enable better conversion into the digital domain given current analog to digital converters. However, in the future, the analog to digital conversion as well as the digital to analog conversion may be effectively performed at typical radio frequencies. Accordingly, in certain embodiments the predistortion circuitry predistorts the signal at RF. As such, depending on the embodiment IF can be RF which is why the mixers 86 and 90 are shown in dash lines.

Additionally, as shown in the illustrative embodiment of FIG. 2, the predistortion circuitry 88 can be adaptive and the predistortion function implemented by the predistortion circuitry 88 can be changed or updated as determined by predistortion function adaptation block 92 (by direct predistortion function calculation or determination and/or amplifier characteristics estimation followed by predistortion function calculation as the inverse of the amplifier characteristics estimation) using one or more of the inputs 94 (or information on the signal to be amplified) and/or output 96 of the amplifier. As would be understood by one of ordinary skill in the art, other parameters may cause the predistortion function of the predistortion circuitry 88 to be adapted. Depending on the embodiment, the predistortion adaptation block 92 may simply downconvert (to IF or baseband) and digitize the input and output samples and perform an amplifier characteristics curve estimation and then calculate the inverse of the characteristics curve to update the predistortion function. In accordance with an aspect of the present invention, the predistortion adaptation circuitry or block 92 need not go down to baseband and/or perform I/Q demodulation to update and/or change the predistortion function.

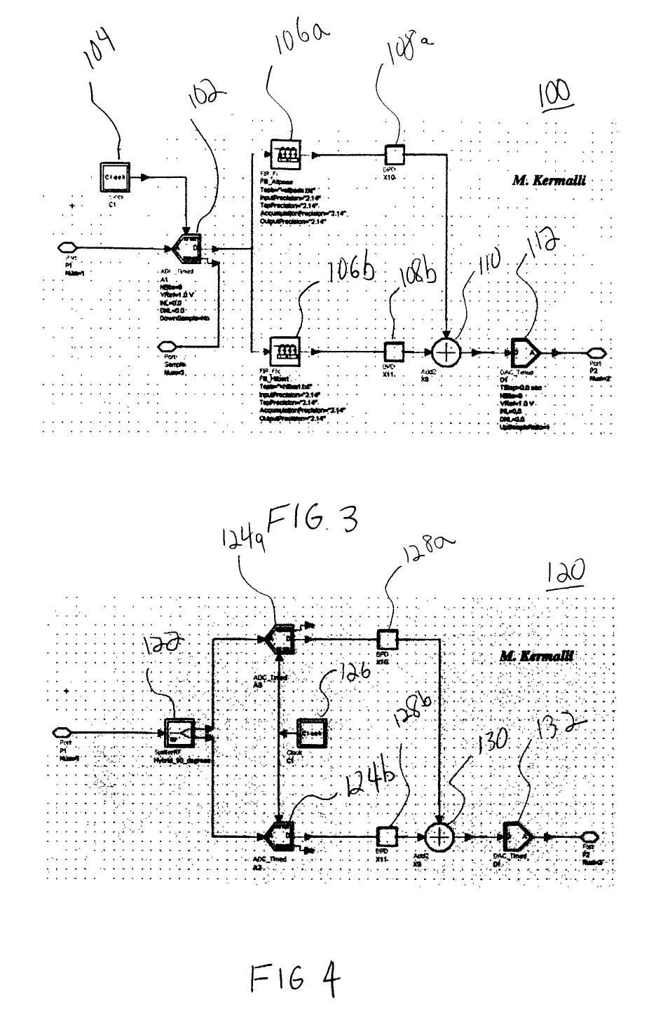

FIG. 3 shows a diagram of an embodiment 100 of the predistortion circuitry 88 of FIG. 2 according to principles of the present invention. In this embodiment, an analog to digital converter (ADC) 102 receives an IF analog signal to be amplified at RF. For example, an RF analog signal to be amplified and transmitted over the air is produced at around 2 Gigahertz (GHz) prior to being input to the predistortion circuitry 100. In accordance with certain principles of the present invention, the RF signal is downconverted to an IF, for example to about 40 Megahetz (MHz). The IF analog signal is provided to the ADC 102 which digitizes the IF signal at a rate determined by clock 104. An all pass Transform 106a is performed on the IF digital signal to produce the I components of the IF digital signal, and a Hilbert Transform 106b is performed on the IF digital signal to produce the Q components of the IF digital signal which are 90 degrees out of phase with the I components. Digital predistortion function 108a modifies or predistorts the I component of the IF digital signal, and digital predistortion function 108b modifies or predistorts the Q component of the IF digital signal. The predistorted I and Q components are combined by adder 110 to produce a predistorted IF digital signal. As such, each component can be predistorted separately and combined in phase to produce a signal with independent gain and/or phase predistortion adjustments. The predistorted IF digital signal is converted to an analog signal by digital to analog converter (DAC) 112 to produce a predistorted IF analog signal which is subsequently upconverted to RF and amplified.

FIG. 4 shows a diagram of an embodiment 120 of the predistortion circuitry 88 of FIG. 2 according to principles of the present invention. In this embodiment, a spitter 122, such as a quadrature hybrid coupler, splits the IF analog signal into I and Q analog components at IF which are 90 degrees out of phase. The I components are provided to an analog to digital converter (ADC) 124a which digitizes the I components at a rate determined by clock 126, and the Q components are provided to an analog to digital converter (ADC) 124b which digitizes the Q components using the same clock 126. Digital predistortion function 128a modifies or predistorts the digitized I components, and digital predistortion function 128b modifies or predistorts the digitized Q components. The predistorted digitized I components and the predistorted digitized Q components are combined by adder 130 to produce a predistorted IF digital signal. As such, each component can be predistorted separately and combined in phase to produce a signal with independent gain and/or phase predistortion adjustments. The predistorted IF digital signal is converted to an analog signal by digital to analog converter (DAC) 132 to produce a predistorted IF analog signal which is subsequently upconverted to RF and amplified.

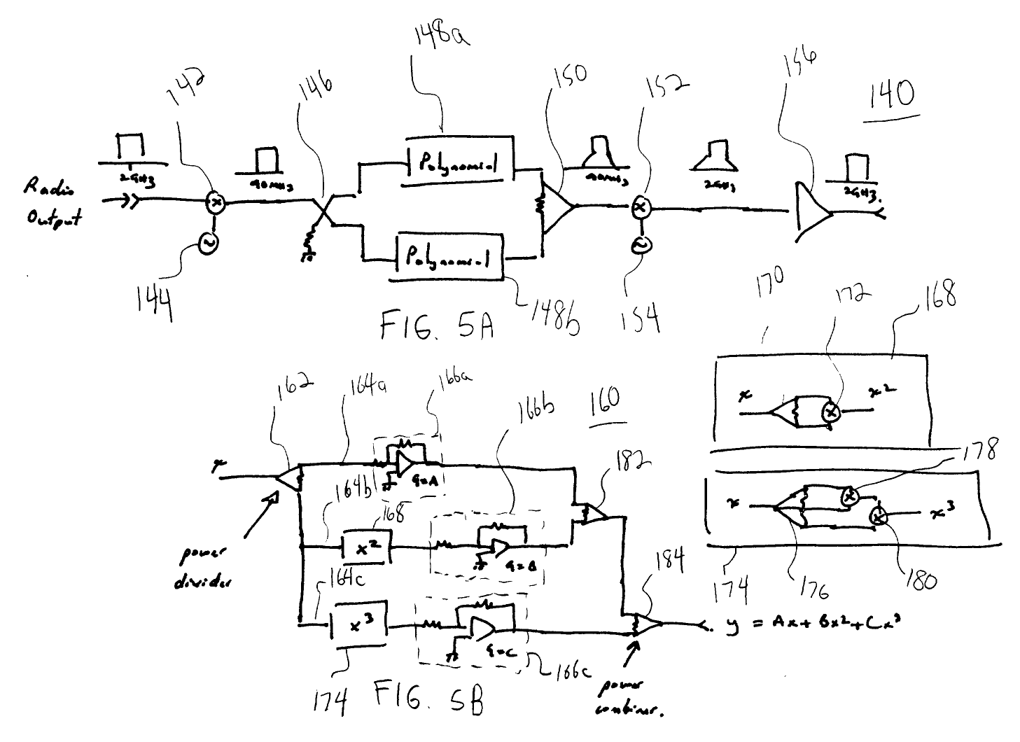

FIG. 5a shows a diagram of an analog embodiment 140 of an IF predistortion system 2 according to principles of the present invention. In this embodiment, an RF analog signal to be amplified and transmitted over the air is produced at around 2 Gigahertz (GHz). In accordance with certain principles of the present invention, the RF signal is downconverted to an IF of about 40 Megahetz (MHz) using a mixer 142 and an oscillator 144. The IF analog signal is provided to a splitter 146, such as a quadrature hybrid coupler, to produce 90 degree out of phase I and Q components of the IF analog signal. Predistortion polynomial 148a modifies or predistorts the analog I components, and predistortion polynomial 148b modifies or predistorts the analog Q components. The predistorted I and Q components are combined by combiner 150 to produce a predistorted IF analog signal. As such, each component can be predistorted separately and combined in phase to produce a signal with independent gain and/or phase predistortion adjustments. The predistorted IF analog signal is upconverted by a mixer 152 and an oscillator 154 to RF, for example to about 2 GHz, to produce a predistorted RF analog signal which is subsequently amplified by amplifier 156.

FIG. 5b shows an embodiment 160 of an analog predistortion polynomial which could be used in the predistortion polynomial 148 of FIG. 5b. As such, in this embodiment, the analog IF signal (for example, the I or Q component) is provided to a power divider 162 which produces the analog IF signal on different branches 164a-c. The branch 164a has multiplication coefficient circuitry 166a which effectively multiplies the analog IF signal x by coefficient A. The branch 164b has multiplication coefficient circuitry 166b which effectively multiplies the squared analog IF signal x² by coefficient B. The squared analog IF signal x² is produced from squaring circuitry 168 which is shown in detail in a separate view 168 using a two way splitter 170 and a mixer or multiplier 172 as shown. The branch 164c has multiplication coefficient circuitry 166c which effectively multiplies the cubed analog IF signal x³ by coefficient C. The cubed analog IF signal x³ is produced from cubing circuitry 174 which is shown in detail in a separate view 174 using a three way splitter 176 and mixers or multipliers 178 and 180 as shown. Power combiners 182 and 184 add the resulting signals on the branches 164a-c to produce the polynomial output. Alternative predistortion functions are possible. For example, additional branches and different circuitry could be added as would be understood by one of ordinary skill in the art to implement different analog predistortion functions.

In addition to the embodiment described above, alternative configurations of the predistortion system according to the principles of the present invention are possible which omit and/or add components and/or use variations or portions of the described system. For example, the predistortion circuitry or portions thereof can be implemented at baseband, intermediate frequency (IF) and/or radio frequency (RF) in the analog and/or digital domain or in other amplifier or electrical circuit arrangements.

The embodiment of the predistortion system has been described in the context of an adaptive predistortion architecture to reduce the distortion generated at the output of an amplifier, but the predistortion system can be used in any predistortion system which is used to reduce the distortion generated by any distortion generating circuitry which acts on a signal. Depending on the application, the predistortion circuitry can be positioned in or in addition to a feed forward or other linearization or efficiency-improving techniques. The predistortion system has been further described as using different configurations of discrete components, but it should be understood that the predistortion system and portions thereof can be implemented in application specific integrated circuits, software-driven processing circuitry, firmware, hardware, discrete components or combination(s) or portion(s) thereof as would be understood by one of ordinary skill in the art with the benefit of this disclosure. What has been described is merely illustrative of the application of the principles of the present invention. Those skilled in the art will readily recognize that these and various other modifications, arrangements and methods can be made to the present invention without strictly following the exemplary applications illustrated and described herein and without departing from the spirit and scope of the present invention.

1. A method of predistorting a signal, said method comprising the steps of:
converting a radio frequency (RF) signal to an intermediate frequency (IF) signal;
predistorting said IF signal; and
converting said predistorted IF signal to RF to produce a predistorted RF signal.

2. The method of claim 1 comprising the steps of:
amplifying said predistorted RF signal and
transmitting said amplified RF signal.

3. The method of claim 1 wherein said step of predistorting comprising the steps of:
converting said IF signal to a digital IF signal;
predistorting said digital IF signal; and
converting into analog said predistorted digital IF signal into said predistorted IF signal.

4. The method of claim 1 wherein said step of predistorting further comprising:
splitting said IF signal into I and Q components;
predistorting said I and Q components;
combining said I and Q components to produce said predistorted IF signal.

5. The method of claim 1 comprising the step of:
changing a predistortion function used in predistorting said IF signal without performing I/Q demodulation.

6. A predistortion system comprising:
predistortion circuitry adapted to convert a radio frequency (RF) signal to an intermediate frequency (IF) signal and to predistort said IF signal and to convert said predistorted IF signal to RF to produce a predistorted RF signal.

7. The predistortion system of claim 6 comprising:
an amplifier adapted to amplify said predistorted RF signal for transmission.

8. The predistortion system of claim 6 wherein said predistortion circuitry adapted to convert said IF signal to a digital IF signal and to predistort said digital IF signal and to convert into analog said predistorted digital IF signal into said predistorted IF signal.

9. The predistortion system of claim 6 wherein said predistortion circuitry adapted to split said IF signal into I and Q components, to predistort said I and Q components and to combine said I and Q components to produce said predistorted IF signal.

10. The predistortion system of claim 6 wherein said predistortion circuitry comprising predistortion adaptation circuitry adapted to change a predistortion function used in predistorting said IF signal without performing I/Q demodulation.

11. A method of predistorting a signal, said method comprising the steps of:
converting a radio frequency (RF) analog signal to an RF digital signal;
predistorting said RF digital signal; and
converting to analog said predistorted RF digital signal to produce a predistorted RF analog signal.

12. The method of claim 11 comprising the steps of:
amplifying said predistorted RF analog signal and
transmitting said amplified RF signal.

13. The method of claim 11 wherein said step of predistorting further comprising:
splitting said RF analog signal into I and Q components;
predistorting digital I and Q components;
combining said digital I and Q components to produce said predistorted RF digital signal.

14. The method of claim 13 comprising the step of:
converting said RF analog signal into said RF digital signal.

15. The method of claim 13 comprising the step of:
splitting said RF analog signal into analog I and Q components; and
converting said analog I and Q components into said digital I and Q components.

16. A predistortion system comprising:
predistortion circuitry adapted to convert a radio frequency (RF) analog signal to an RF digital signal, to predistort said RF digital signal, and to convert to analog said predistorted RF digital signal to produce a predistorted RF analog signal.

17. The system of claim 16 comprising:
an amplifier adapted to amplify said predistorted RF analog signal for transmission.

18. The system of claim 16 wherein said predistortion circuitry is adapted to split said RF analog signal into I and Q components, to predistort digital I and Q components, and to combine said digital I and Q components to produce said predistorted RF digital signal.

19. The system of claim 18 wherein said predistortion circuitry is adapted to convert said RF analog signal into said RF digital signal.

20. The system of claim 18 wherein said predistortion circuitry is adapted to split said RF analog signal into analog I and Q components and to convert said analog I and Q components into said digital I and Q components.
